(19) United States
(12) Patent Application Publication
(10) Pub. No.: US 2005/0179638 A1
(43) Pub. Date: Aug. 18, 2005

(54) Method for changing color in mobile terminal

(75) Inventors: Eun-Jung Seo, Busanlingu (KR); Jeong-Wook Seo, Buk-gu (KR); Hae-Young Park, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/059,319

(22) Filed: Feb. 17, 2005

(30) Foreign Application Priority Data
Feb. 17, 2004 (KR) 2004-10284

(51) Int. Cl. G09G 3/36

(52) U.S. Cl. 345/102

(57) ABSTRACT

A method for changing the backlight color in a mobile terminal including steps for setting a temperature measuring mode and a color changing mode for changing the backlight color in the mobile terminal and measuring an ambient temperature of the mobile terminal, controlling the mobile terminal to change the backlight color in the mobile terminal according to the measured temperature, and lighting the mobile terminal with the backlight color changed according to the measured temperature. The backlight color is changed according to the measured temperature, therefore, the visual effect can be varied and provided to the user, breaking from the fixed backlight color of the conventional display unit and keypad, and visual temperature information can be provided to the user as well.

### CROSS-REFERENCE TO RELATED APPLICATIONS

This application claims the benefit under 35 U.S.C. §119(a) of Korean Patent Application No. 2004-10284 entitled “Method for Changing Color in Mobile Terminal” filed in the Korean Intellectual Property Office on Feb. 17, 2004, the entire contents of which are hereby incorporated by reference.

### BACKGROUND OF THE INVENTION

1. Field of the Invention

The present invention relates generally to a mobile terminal. More particularly, the present invention relates to a method for changing illumination color in a mobile terminal that can change a backlight color and a background scene of a display keypad, a display window, and the like, in accordance with temperatures measured by a thermometer provided in the mobile terminal.

2. Description of the Related Art

Typically, a mobile terminal may be divided into an input means, a control means for controlling the operation of the mobile terminal according to key signals input through the input means, and an output means for displaying output data under the control of the control means. The input means may be a keypad having a plurality of key buttons, and the output means may be an LCD display unit.

For the use of such a mobile terminal at night, the keypad and the display unit may further have a backlight function, so that a user can easily perform a key manipulation and can view output data displayed on the display unit even at night.

In this case, the illumination color of the backlight of the key pad and the display unit is typically fixed, or set by the user, to a single color.

Accordingly, in order to satisfy the increasing control and feature desires of users, a need exists for a system and method to easily change the backlight color of the keypad and the display unit. Additionally, a need exists for a system and method to easily provide daily information through the change of the backlight color in addition to providing the information via a simple visual effect.

### SUMMARY OF THE INVENTION

Accordingly, the present invention has been designed to solve the above and other problems occurring in the prior art, and an object of the present invention is to provide a mobile terminal that can change the backlight color of a keypad and a display window.

Another object of the present invention is to provide a method for changing the illumination color in a mobile terminal that can change the backlight color of a keypad and a display window, in accordance with an ambient temperature of the mobile terminal as measured by an ambient temperature measuring means provided in the mobile terminal.

In order to accomplish the above and other objects, a method is provided for changing the illumination color in a mobile terminal comprising the steps of setting a temperature measuring mode and a color changing mode for changing the backlight color in the mobile terminal and for measuring an ambient temperature of the mobile terminal, controlling the terminal to change the backlight color in the mobile terminal according to the measured temperature, and lighting with the illumination color changed according to the measured temperature.

### BRIEF DESCRIPTION OF THE DRAWINGS

The above and other objects, features and advantages of the present invention will become more apparent from the following detailed description taken in conjunction with the accompanying drawings, in which:

FIG. 1 is a block diagram illustrating a mobile terminal according to an embodiment of the present invention;

FIG. 2 is a flowchart illustrating a method for displaying an ambient temperature measured through a mobile terminal according to an embodiment of the present invention;

FIG. 3 is a flowchart illustrating a method for displaying an ambient temperature measured through a mobile terminal according to another embodiment of the present invention;

FIGS. 4a and 4b are views illustrating examples of the display state of the measured temperature provided through a display unit;

FIG. 5 is a flowchart illustrating a method for changing backlight color in a mobile terminal according to an embodiment of the present invention;

FIG. 6 is a flowchart illustrating a process of setting a backlight color changing mode in a mobile terminal according to an embodiment of the present invention; and

FIG. 7 is a flowchart illustrating a backlighting process if the temperature range is set to the spring season selection according to an embodiment of the present invention.

Throughout the drawings, like reference numerals will be understood to refer to like parts, components and structures.

### DETAILED DESCRIPTION OF THE EXEMPLARY EMBODIMENTS

Exemplary embodiments of the present invention will be described in greater detail hereinafter with reference to the accompanying drawings. In the following description of the present invention, same drawing reference numerals are used for the same elements, even when in different drawings. Additionally, a detailed description of known functions and configurations incorporated herein will be omitted when it may obscure the subject matter of the present invention.

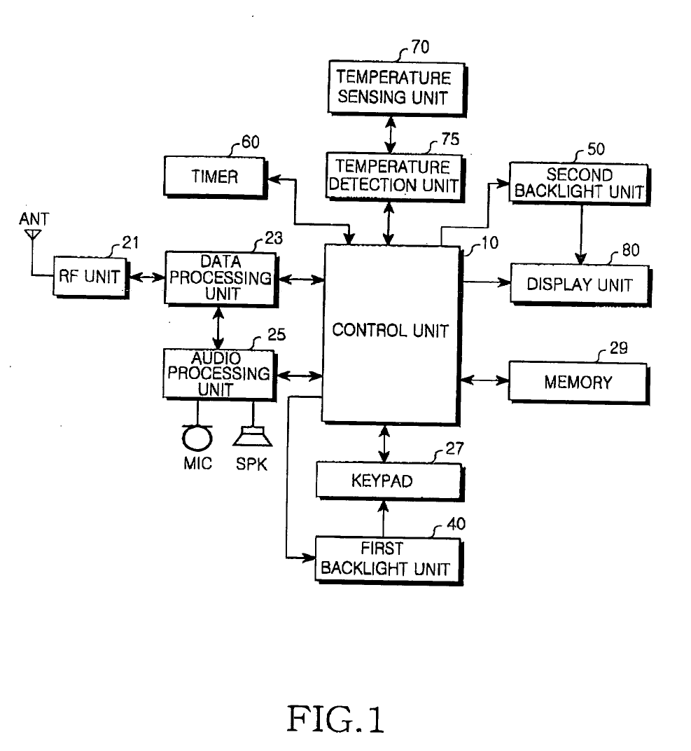

FIG. 1 is a block diagram illustrating a mobile terminal according to an embodiment of the present invention.

Referring to FIG. 1, an RF (Radio Frequency) unit 21 performs a communication function of the mobile terminal. The RF unit 21 includes an RF transmitter for up-converting and amplifying the frequency of a transmitted signal, and an RF receiver for low-noise-amplifying and down-converting the frequency of a received signal.

A data processing unit 23 includes a transmitter for encoding and modulating the transmitted signal, a receiver for demodulating and decoding the received signal and the like. That is, the data processing unit 23 may be provided with a modem and a codec.

An audio processing unit 25 reproduces an audio signal output from the data processing unit 23, or transmits an audio signal produced from a microphone MIC to the data processing unit 23. Additionally, in the embodiment of the present invention shown in FIG. 1, the audio processing unit 25 outputs a voice signal for guidance, or a warning sound to a speaker SPK, if the ambient temperature is more than a preset upper limit temperature that is considered to correspond to the occurrence of a fire.

A keypad 27 is provided with keys for inputting numerals and characters, and with function keys for setting various kinds of functions.

A first backlight unit 40 backlights the keypad 27 according to a backlight control signal. Additionally, in an embodiment of the present invention shown in FIG. 1, the first backlight unit 40 can change the illumination color of the backlight in response to the backlight control signal produced according to a measured temperature.

A temperature sensing unit 70 is located on an external surface of the mobile terminal, and measures the ambient temperature. In this example, the temperature sensing unit 70 may comprise a thermistor (not shown), the resistance value of which is varied according to the ambient temperature.

A temperature detection unit 75 detects the measured temperature from the temperature sensing unit 70 by detecting the resistance value of the temperature sensing unit 70.

A memory 29 may comprise a program memory and a data memory. The specified stages of a temperature range corresponding to backlight colors to be changed, according to the measured temperature, are stored in the program memory. Also stored in the program memory, a table of temperature values corresponding to different resistance values detected by the temperature sensing unit 70, is stored as a database. Additionally, a program for changing the backlight colors of the keypad 27 and a display unit 80 according to the measured temperature is stored in the program memory. Data produced while the program is executed is temporarily stored in the data memory.

A timer 60 counts time and measures intervals for measuring the temperature.

A control unit 10 controls the operations of the mobile terminal, and may include the data processing unit 23. Additionally, the control unit 10 outputs a backlight control signal for backlighting with an illumination color according to the specified stages of the temperature range to which the temperature values input from the temperature detection unit 75 belong, and for displaying the measured temperature on the display unit 80 once the time counted by the timer 60 reaches a predetermined time.

The display unit 80 displays messages produced during the execution of the programs under the control of the control unit 10. Additionally, the display unit 80 displays user data output from the control unit 10 and an ambient temperature detected by the temperature sensing unit 70 according to the embodiment of the present invention. In this example, the display unit 80 may comprise an LCD, and in this case, the display unit 80 may be provided with an LCD controller, a memory for storing video data, an LCD display device and the like. If a touch screen type LCD is provided, the keypad 27 and the LCD may also function as an input unit.

A second backlight unit 50 backlights the display unit 80 according to the backlight control signal. Additionally, the second backlight unit 50 can change the backlight color in response to the backlight control signal produced according to the measured temperature.

The operation of the mobile terminal as constructed above will now be described in greater detail with reference to FIG. 1.

If a user sets an originating mode after he or she performs a dialing operation through the keypad 27, the control unit 10 recognizes this, processes the dial information received through the data processing unit 23, and then converts the dial information into an RF signal through the RF unit 21. If an opposite party generates a response signal, the control unit 10 recognizes this through the RF unit 21 and the data processing unit 23. The user then performs communications through a speech path formed through the audio processing unit 25.

In a destination mode, the control unit 10 recognizes this through the data processing unit 23, and generates a ring signal through the audio processing unit 25. If the user responds, the control unit 10 recognizes this, and performs communications through a speech path formed through the audio processing unit 25. Although it is exemplified that the speech communication is performed in the originating and destination modes, a data communication function for transmitting and/or receiving packet data and video data can also be performed in addition to the speech communication.

In a standby mode or if a text communication is performed, the control unit 10 controls the display unit 30 to display text data processed through the data processing unit 23.

Additionally, the mobile terminal of FIG. 1 can measure the ambient temperature through the temperature sensing unit 70. The temperature sensing unit 70 may employ a thermistor having any of the following types. A bead type thermistor can be used which is covered with glass, and has a superior reliability, stability and is airtight so that it can be used at a high temperature. A disk type thermistor can be used which is low-priced, and allows mass production. A chip type thermistor can be used which is small-sized and low-priced, coming next to the bead type thermistor, and also allows mass production. The chip type thermistor is normally suitable to the measurement of temperatures up to about 150° C., and a piezoelectric type thermistor can measure temperatures in the range of about 200° C. to about 300° C.

In the exemplary embodiment of the present invention, the temperature sensing unit 70 comprises the chip type thermistor which is small-sized and low-priced, and which allows mass production. The ambient temperature measured through the temperature sensing unit 70 as described above, is then displayed on the display unit 80 through the following process.

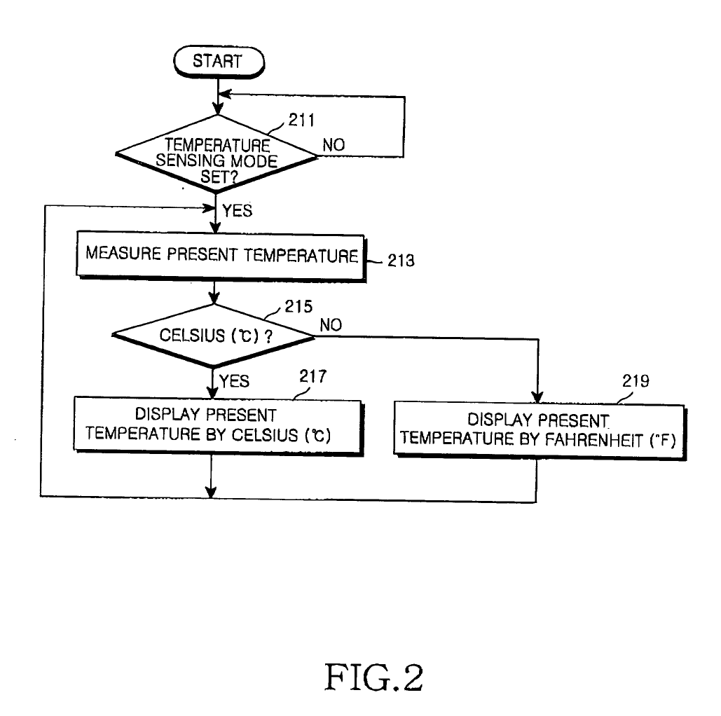

FIG. 2 is a flowchart illustrating an exemplary method for displaying an ambient temperature measured through a mobile terminal according to an embodiment of the present invention. Referring to FIG. 2, the control unit 10 judges whether a temperature measuring mode is set at step 211, and if the temperature measuring mode is set, the control unit 10 measures the present temperature at step 213.

After the measurement of the temperature, the control unit 10 confirms whether the user has selected to display the measured temperature by Celsius (° C.) or by Fahrenheit (° F.) at step 215. If the display of the measured temperature is set by Celsius (° C.), the control unit 10 controls the display unit 80 to display the ambient temperature by Celsius (° C.) at step 217. If the display of the measured temperature is set by Fahrenheit (° F.), the control unit 10 controls the display unit 80 to display the ambient temperature by Fahrenheit (° F.) at step 219.

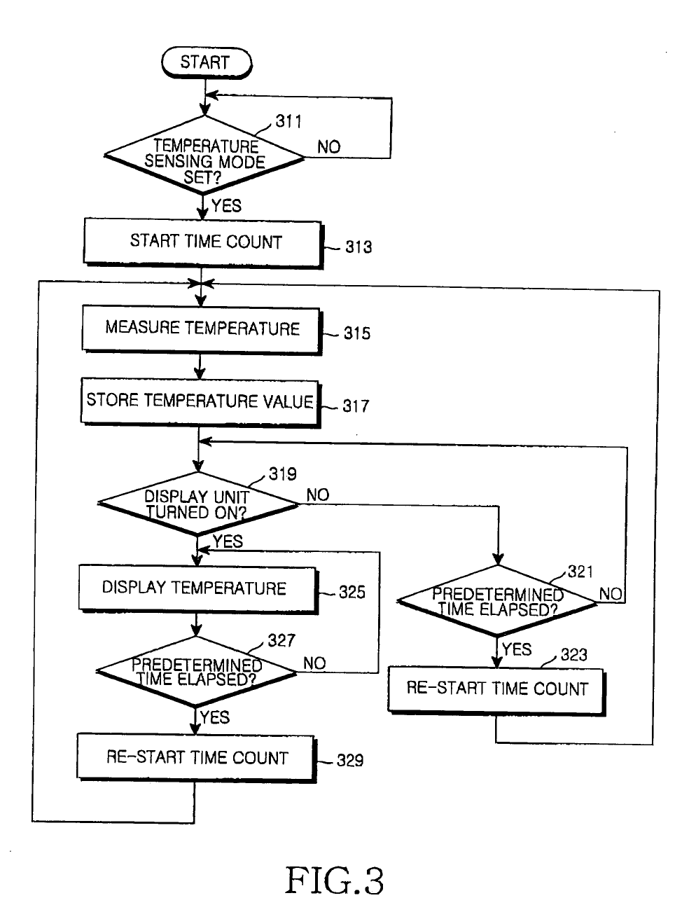

FIG. 3 is a flowchart illustrating an exemplary method for displaying an ambient temperature measured through a mobile terminal according to another embodiment of the present invention. Referring to FIG. 3, the control unit 10 judges whether a temperature sensing, or measuring mode is set at step 311, and if the temperature measuring mode is set, the control unit proceeds to step 313 and the timer 60 starts a time count.

The control unit 10 then receives and measures the temperature from the temperature detection unit 75, which is provided for detecting the resistance value that varies according to the temperature sensed by the temperature sensing unit 70 at step 315, and then proceeds to step 317 to store the measured temperature in the memory 29.

The control unit 10 then judges whether the display unit 80 is in an on state at step 319. If the display unit 80 is not in an on state, that is, if the display is in an off state, the control unit 10 proceeds to step 321 and re-measures the temperature after restarting the time count or again determines if the display unit 80 is on, according to whether the time counted by the timer 60 reaches a predetermined time. That is, if the time counted by the timer 60 reaches the predetermined time, the control unit 10 restarts the time count at step 323 and returns to the step 315 to repeat the above-described temperature measuring process.

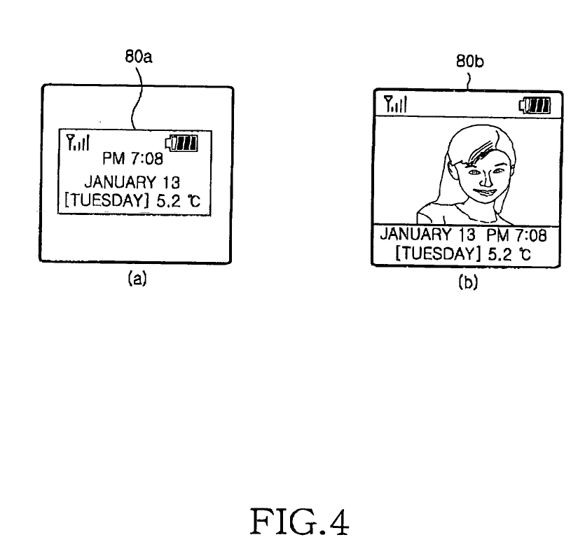

However, if the display unit 80 is in an on state as a result of the judgment at step 319, the control unit 10 proceeds to step 325 and controls the display unit 80 to display the temperature which was stored in the memory 29 at step 317. In this case, the display unit 80 may display the measured temperature as illustrated in FIGS. 4a and 4b. In this example, the display unit 80 is divided into an external display unit 80a and an internal display unit 80b. On the external display unit 80a as illustrated in FIG. 4a, icons are displayed for indicating the receiving rate and the residual quantity of the battery, the present time and date information, and the measured ambient temperature. On the internal display unit 80b as illustrated in FIG. 4b, a standby scene is displayed along with the icons and the information displayed on the external display unit 80a. Accordingly, in the case of a folder-type mobile terminal, the user can see the ambient temperature through the external display unit 80a without opening the folder.

The process of changing the backlight color of the display unit 80 and the keypad 27 of the mobile terminal in accordance with the temperature measured through the mobile terminal as described above, will now be described in greater detail.

The resistance value of the temperature sensing unit 70 is varied according to the sensed temperature, and the varied resistance value is detected at predetermined intervals through the temperature detection unit 75 under the control of the control unit 10.

The control unit 10 then reads out a temperature value from the memory 29 corresponding to the resistance value input from the temperature detection unit 75. Additionally, the control unit 10 judges to which stage of the season selection temperature range that the readout temperature belongs, and controls the first and second backlight units 40 and 50 to light or illuminate with the backlight color corresponding to the judged stage of the selected season temperature range.

The first and second backlight units 40 and 50 then change the backlight color according to the backlight control signal from the control unit 10, and light the keypad 27 and/or the display unit 80 with the changed illumination color.

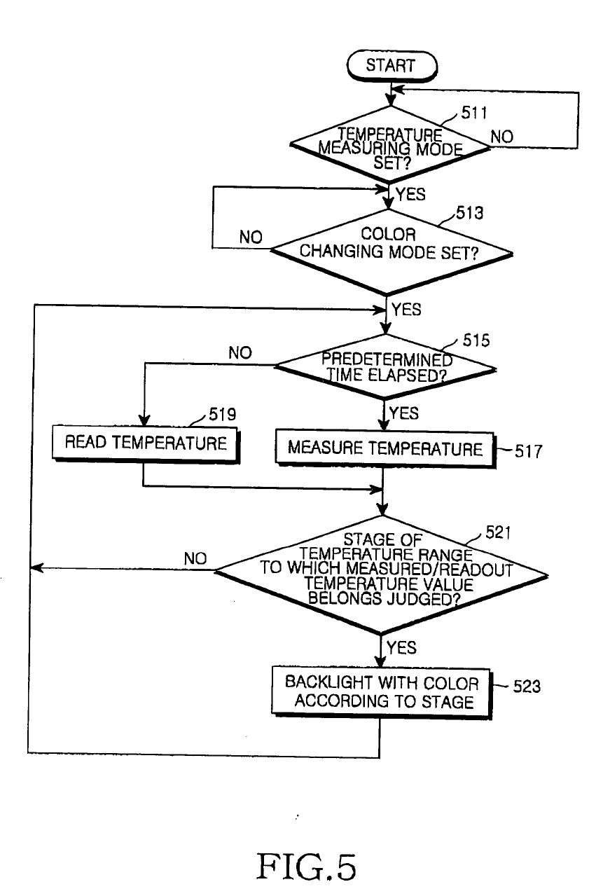

FIG. 5 is a flowchart illustrating an exemplary method for changing the backlight color in a mobile terminal according to an embodiment of the present invention.

Referring to FIG. 5, the control unit 10 judges whether the temperature measuring mode is set at step 511. If the temperature measuring mode is set, the control unit 10 proceeds to step 513 and judges whether a color changing mode for automatically changing the backlight color of the display unit 80 and/or the keypad 27 according to the measured temperature is set. The process of setting the color changing mode is described in greater detail below.

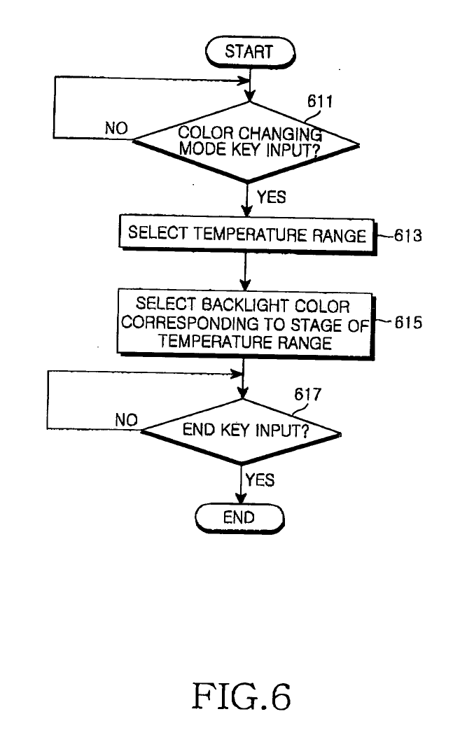

FIG. 6 is a flowchart illustrating an exemplary process of setting the color changing mode in a mobile terminal according to an embodiment of the present invention.

Referring to FIG. 6, the control unit 10 judges whether a color changing mode key is input at step 611. If the color changing mode key is input, the control unit 10 provides backlight colors of the first and second backlight units 40 and 50 for backlighting the display unit 80 and the keypad 27 to the user so that the user can set the backlight colors and the temperature stages. The control unit 10 then provides backlight colors according to the measured temperature and specified stages of a temperature range corresponding to the backlight colors.

The user selects the temperature range according to the four seasons (that is, spring, summer, fall and winter) at step 613. For example, spring, summer, fall and winter can have temperature ranges of about 0° C.˜15° C., 20° C.˜35° C., 5° C.˜20° C., and −5° C.˜10° C., respectively. That is, different temperature ranges are given to the four seasons, and each season has a temperature range of about 15° C.

These exemplary temperature ranges are described in Table 1 below.

TABLE 1

| | Temperature Range |
|---|---|
| Spring | 0° C.˜15° C. |
| Summer | 20° C.˜35° C. |
| Fall | 5° C.˜20° C. |
| Winter | −5° C.˜10° C. |

The user then selects the backlight colors corresponding to the stages of the selected season temperature range at step 615. The backlight colors corresponding to the stages are set by default to red, orange, yellow, green, and blue, and can be changed by the user as needed.

For example, because the temperature range of each season is about 15° C., it can be divided into 5 stages, each of which has the temperature range of 3° C., as described in Table 2 below.

TABLE 2

| | Color of First |
|---|---|
| | and Second |
| Temperature | Backlight Units |
| Minimum ° C.˜Minimum + 3° C. (First Stage) | Red |
| Minimum + 3° C.˜Minimum + 6° C. (Second Stage) | Orange |
| Minimum + 6° C.˜Minimum + 9° C. (Third Stage) | Yellow |
| Minimum + 9° C.˜Minimum + 12° C. (Fourth Stage) | Green |
| Minimum + 12° C.˜Minimum + 15° C. (Fifth Stage) | Blue |

After the backlight colors corresponding to the specified stages of the selected season temperature range are set, the control unit 10 judges whether an end key is input at step 617, and if the end key is input, the control unit terminates the process of setting the color changing mode.

Returning to FIG. 5, if the color changing mode set through the process of FIG. 6 is set at step 513, the control unit 10 proceeds to step 515 and judges whether the time counted by the counter 60 reaches the predetermined time. The time interval is provided to judge whether to measure the temperature again, or to change the backlight color of the display unit 80 and/or the keypad 27 based on the previously measured temperature because the temperature is measured for the predetermined time. Here, it is assumed that the predetermined time is set to one minute.

If the predetermined time (i.e., one minute) elapses, the control unit 10 measures the temperature through the methods as illustrated in FIGS. 2 and 3 at step 517.

If the predetermined time does not elapse, the control unit 10 reads out the temperature value measured through the methods as illustrated in FIGS. 2 and 3 and stored in the memory 29 at step 519.

At step 521, the control unit 10 then judges to which stage the temperature value readout at step 519 or the measured temperature value at step 517 belongs. The control unit 10 then proceeds to step 523 according to a result of the judgment, and controls the terminal to backlight the display unit 80 and/or the keypad 27 with the illumination color corresponding to the stage of the temperature range to which the measured temperature value belongs.

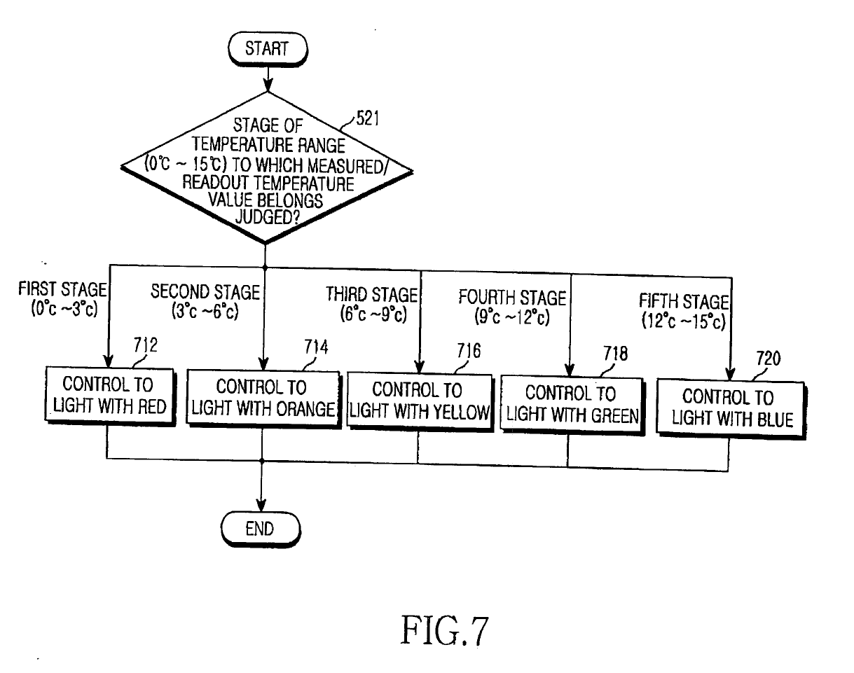

Hereinafter, an exemplary process of backlighting with the illumination color changed according to the readout or measured temperature is described for an example where the spring season (temperature range of 0° C.˜15° C.) is selected as the temperature range with reference to FIG. 7.

FIG. 7 is a flowchart illustrating the backlighting process if the temperature range is set to the spring season (temperature range of 0° C.˜15° C.) according to an embodiment of the present invention. Additionally, the first to fifth stages of the spring season temperature range are set to correspond to the backlight colors of red, orange, yellow, green, and blue, respectively.

If the temperature measured or readout according to the judgment at step 521 belongs to the first stage (0° C.˜3° C.) of the spring season selection, the control unit 10 controls the first and second backlight units 40 and 50 to backlight the display unit 80 and/or the keypad 27 with red illumination at step 712.

If the measured or readout temperature belongs to the second stage (3° C.˜6° C.) of the spring season selection, the control unit 10 controls the first and second backlight units 40 and 50 to backlight the display unit 80 and/or the keypad 27 with orange illumination at step 714.

If the measured or readout temperature belongs to the third stage (6° C.˜9° C.) of the spring season selection, the control unit 10 controls the first and second backlight units 40 and 50 to backlight the display unit 80 and/or the keypad 27 with yellow illumination at step 716.

If the measured or readout temperature belongs to the fourth stage (9° C.˜12° C.) of the spring season selection, the control unit 10 controls the first and second backlight units 40 and 50 to backlight the display unit 80 and/or the keypad 27 with green illumination at step 718, and if the measured or readout temperature belongs to the fifth stage (12° C.˜15° C.) of the spring season selection, the control unit 10 controls the first and second backlight units 40 and 50 to backlight the display unit 80 and/or the keypad 27 with blue illumination at step 720.

As described above, according to the present invention, the backlight color is changed according to the temperature measured through a temperature measuring means provided in a mobile terminal, and thus, the visual effect can be varied and provided to the user, thereby breaking from the fixed backlight color of the display unit and the keypad. Temperature information can be provided to the user as well.

While the present invention has been shown and described with reference to certain exemplary embodiments thereof, it will be understood by those skilled in the art that various changes in form and details may be made therein without departing from the spirit and scope of the present invention as defined by the appended claims.

1. A method for changing backlight color in a mobile terminal, comprising the steps of;
setting a temperature measuring mode for measuring an ambient temperature of the mobile terminal;
setting a color changing mode for changing the backlight color in the mobile terminal;
controlling the mobile terminal to change the backlight color in the mobile terminal according to the measured temperature; and
lighting with the backlight color changed according to the measured temperature.

2. The method as claimed in claim 1, wherein the step of controlling the mobile terminal to change the backlight color comprises the steps of:
judging to which stage the measured temperature belongs from among a plurality of specified stages of a temperature range; and
lighting with the backlight color corresponding to the stage of the temperature range to which the measured temperature belongs.

3. The method as claimed in claim 1, wherein the step of measuring the ambient temperature comprises the steps of:
judging whether a temperature measuring mode is set and measuring the present temperature if the temperature measuring mode is set;
judging whether a display unit of the measured temperature is set to Celsius (° C.) and displaying the measured temperature by Celsius (° C.) if the display unit is set to Celsius (° C.); and
displaying the measured temperature by Fahrenheit (° F.) if the display unit of the measured temperature is not set to Celsius (° C.).

4. The method as claimed in claim 1, wherein the step of measuring the ambient temperature comprises the steps of:
judging whether a temperature measuring mode is set and measuring and storing the present temperature at predetermined intervals if the temperature measuring mode is set; and
displaying the measured and stored temperature on a display unit.

5. The method as claimed in claim 4, wherein the step of displaying the measured and stored temperature comprises the steps of:
judging whether the display unit is in an on state and displaying the measured and stored temperature if the display unit is in the on state;
judging whether a predetermined time elapses and measuring the temperature for the predetermined time by re-starting a time count if the predetermined time elapses; and
judging whether the predetermined time elapses if the display unit is not in an on state, and measuring the temperature for the predetermined time by re-starting the time count if the predetermined time elapses and repeatedly judging whether the display unit is in an on state if the predetermined time does not elapse.

6. The method as claimed in claim 1, wherein the step of setting the color changing mode comprises the steps of:
selecting a temperature range; and
selecting backlight colors corresponding to specified stages of the temperature range.

7. The method as claimed in claim 6, wherein the backlight colors corresponding to specified stages of the temperature range comprise at least one of a red, orange, yellow, green, and blue illumination color.

8. The method as claimed in claim 6, wherein the step of selecting a temperature range comprises a step for selecting a season corresponding to the temperature range.

9. The method as claimed in claim 8, wherein the season comprises at least one of a spring, fall, summer, and winter season.

10. The method as claimed in claim 1, wherein the step of lighting with the backlight color changed according to the measured temperature performs a lighting operation by re-measuring the temperature for a specified time period.
